(19) United States
(12) Patent Application Publication
(10) Pub. No.: US 2017/0299995 A1
(43) Pub. Date: Oct. 19, 2017

(54) IMAGE FORMING APPARATUS

(71) Applicant: KYOCERA Document Solutions Inc., Osaka (JP)

(72) Inventors: Shunsuke Yamasaki, Osaka (JP); Yoshiyuki Asakawa, Osaka (JP); Masuo Kawamoto, Osaka (JP)

(21) Appl. No.: 15/490,728

(22) Filed: Apr. 18, 2017

(30) Foreign Application Priority Data
Apr. 19, 2016 (JP) 2016-083549

(51) Int. Cl. G03G 15/00; B41J 13/10

(52) U.S. Cl. CPC G03G 15/6502; B41J 13/10

(57) ABSTRACT

An image forming apparatus includes a sheet cassette, a sheet conveying portion, an image forming portion, a position detecting portion, and an image position correcting portion. The sheet conveying portion conveys a sheet from the sheet cassette attached to the apparatus main body, along a sheet conveyance path whose width direction matches the main direction. The position detecting portion detects a position of a detection-target portion that is a part of the sheet cassette, in the main direction based on the apparatus main body. The image position correcting portion corrects an image formation position in the main direction at which the image is formed by the image forming portion, based on the position detected by the position detecting portion.

### INCORPORATION BY REFERENCE

This application is based upon and claims the benefit of priority from the corresponding Japanese Patent Application No. 2016-083549 filed on Apr. 19, 2016, the entire contents of which are incorporated herein by reference.

### BACKGROUND

The present disclosure relates to an image forming apparatus that includes a sheet cassette.

A typical image forming apparatus includes one or more sheet cassettes that can be attached to and drawn out from an apparatus main body along a predetermined attachment direction. Sheets are fed out one by one from any sheet cassette into a sheet conveyance path, and an image forming portion forms an image on a sheet conveyed along the sheet conveyance path.

A sheet fed out from the sheet cassette may be conveyed along the sheet conveyance path whose width direction matches the attachment direction. In this case, when the sheet cassette is positionally deviated with respect to the apparatus main body in the attachment direction, the image formed on the sheet is deviated in the width direction of the sheet.

In addition, there is known an image forming apparatus equipped with a mechanism that facilitates a positional adjustment of the sheet cassette in the attachment direction. It is noted that in an electrophotographic image forming apparatus, the positional adjustment is referred to as an optical axis adjustment or the like.

### SUMMARY

An image forming apparatus according to an aspect of the present disclosure includes a sheet cassette, a sheet conveying portion, an image forming portion, a position detecting portion, and an image position correcting portion. The sheet cassette is configured to store sheets and be attached to and drawn out from an apparatus main body along a main direction. The sheet conveying portion is configured to convey a sheet from the sheet cassette attached to the apparatus main body, along a sheet conveyance path whose width direction matches the main direction. The image forming portion is configured to form an image on the sheet conveyed along the sheet conveyance path. The position detecting portion is configured to detect a position of a detection-target portion that is a part of the sheet cassette, in the main direction on a basis of the apparatus main body. The image position correcting portion is configured to correct an image formation position in the main direction at which the image is formed by the image forming portion, based on the position detected by the position detecting portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment of the present disclosure.

FIG. 2 is a perspective view of a sheet cassette included in the image forming apparatus according to the embodiment.

FIG. 3 is a perspective view of a main part of the sheet cassette included in the image forming apparatus according to the embodiment.

FIG. 4 is a perspective view of a sheet supply portion in the image forming apparatus according to the embodiment.

FIG. 5 is a partial sectional side view of a sheet position detecting portion before the sheet cassette is attached, in the image forming apparatus according to the embodiment.

FIG. 6 is a partial sectional side view of the sheet position detecting portion after the sheet cassette is attached, in the image forming apparatus according to the embodiment.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

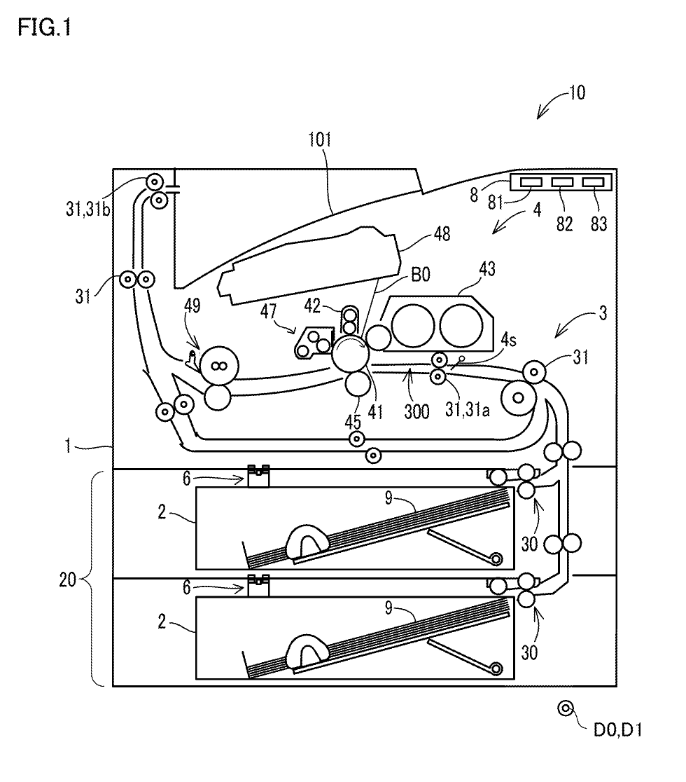

First, a description is given of a configuration of an image forming apparatus 10 according to an embodiment of the present disclosure, with reference to FIG. 1. The image forming apparatus 10 is an electrophotographic image forming apparatus configured to form an image on a sheet 9. The sheet 9 is a sheet-like image formation medium such as a sheet of paper, an envelope, or an OHP sheet.

The image forming apparatus 10 includes sheet cassettes 2, a sheet conveying portion 3, an image forming portion 4, and a control portion 8. The sheet cassettes 2 are attached to a sheet supply portion 20 provided in a lower portion of a main body 1 of the image forming apparatus 10.

It is noted that the main body 1 is composed of: a non-movable support portion that supports the movable sheet cassettes 2 in the image forming apparatus 10; and a non-movable member integrally coupled with the support portion. For example, the main body 1 includes a frame that supports the image forming portion 4, and a member fixed to the frame.

The sheet supply portion 20 is configured to store sheets 9 and be attached to and draw out from the main body 1 along a main direction D0.

The sheet conveying portion 3 is a mechanism that conveys a sheet 9 from the sheet cassette 2 attached to the main body 1, along a sheet conveyance path 300 whose width direction matches the main direction D0. The sheet conveyance path 300 is formed in the main body 1.

The sheet conveying portion 3 includes a sheet feed portion 30 configured to feed the sheets 9 one by one from any of the sheet cassettes 2 into the sheet conveyance path 300. The direction in which the sheet feed portion 30 feeds the sheet 9 is perpendicular to the main direction D0.

Furthermore, the sheet conveying portion 3 includes a plurality of conveyance rollers 31 that take over the conveyance of the sheet 9 from the sheet feed portion 30 and convey the sheet 9 along the sheet conveyance path 300. The plurality of conveyance rollers 31 include a discharge roller 31b that discharges the sheet 9 from an exit of the sheet conveyance path 300 to a discharge tray 101.

In the following description, a movement direction of each sheet cassette 2 when attached to the main body 1 along the main direction D0, is referred to as an attachment direction D1. In addition, a direction opposite to the attachment direction D1, namely, a movement direction of each sheet cassette 2 when drawn out from the main body 1, is referred to as a draw-out direction D2. It can also be said that the width direction of the sheet conveyance path 300 is the attachment direction D1.

In the present embodiment, the attachment direction D1 is directed from the front face of the image forming apparatus 10 to the rear face. In this case, the sheet feed portion 30 feeds each sheet 9 into the sheet conveyance path 300 at an end of the sheet cassettes 2 close to one of opposite side faces of the image forming apparatus 10.

It is noted that the attachment direction D1 may be directed from one of opposite side faces of the image forming apparatus 10 to the other. In this case, the sheet feed portion 30 feeds each sheet 9 into the sheet conveyance path 300 at an end of the sheet cassettes 2 close to the front face or rear face of the image forming apparatus 10.

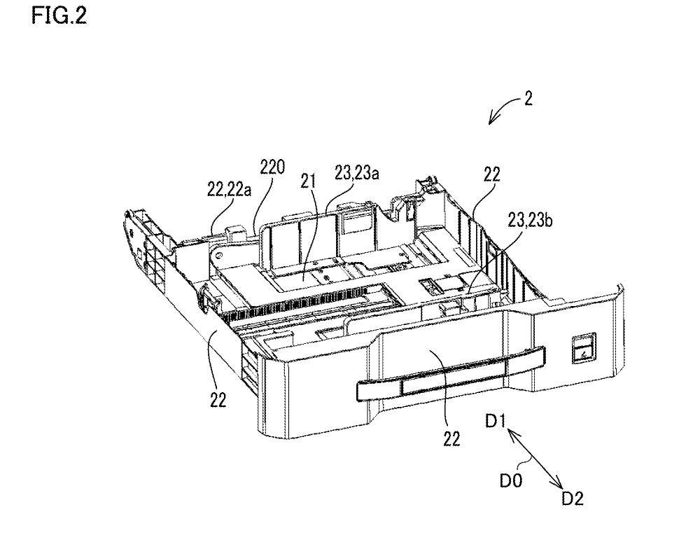

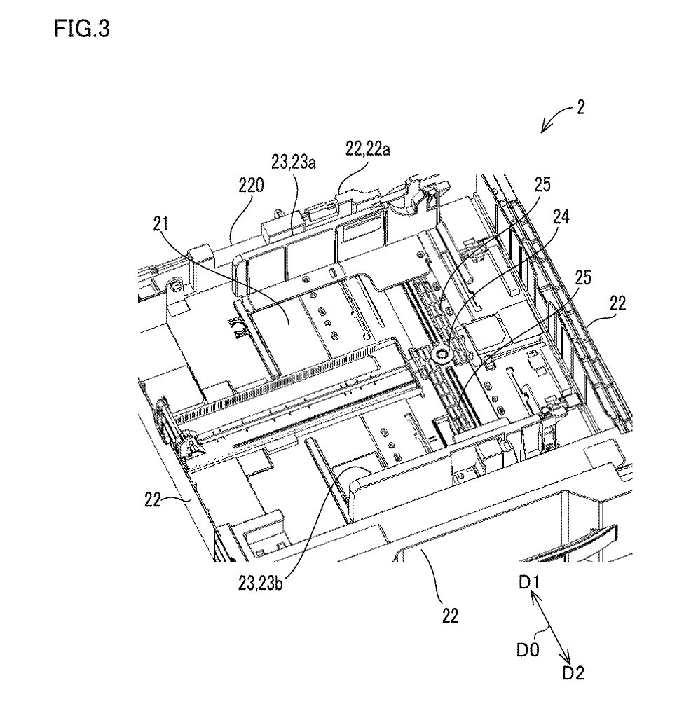

As shown in FIG. 2 and FIG. 3, each sheet cassette 2 includes a bottom plate portion 21, four partition wall portions 22, and a pair of movable sheet guides 23. Furthermore, each sheet cassette 2 has a so-called rack and pinion mechanism which includes a pinion 24 and a pair of racks 25.

The bottom plate portion 21 and the four partition wall portions 22 raised from the bottom plate portion 21 form walls that surround a storage portion of the sheets 9 in respective directions. The rack and pinion mechanism is mounted on the bottom plate portion 21.

The pair of movable sheet guides 23 are disposed in each sheet cassette 2 to face each other in the main direction D0. The pair of movable sheet guides 23 are provided in such a way as to be displaced along the main direction D0 by the rack and pinion mechanism.

In the following description, an end of the sheets 9 in each sheet cassette 2 on the attachment direction D1 side is referred to as an innermost end, and an end on the draw-out direction D2 side is referred to as a front end.

One of the pair of movable sheet guides 23 is a first movable sheet guide 23a located on the downstream side in the attachment direction D1, and the other is a second movable sheet guide 23b located on the upstream side in the attachment direction D1.

The first movable sheet guide 23a is positioned to extend along the innermost end of the sheets 9 in each of the sheet cassettes 2. In addition, the second movable sheet guide 23b is positioned to extend along the front end of the sheets 9 in each of the sheet cassettes 2.

The image forming portion 4 forms an image on the sheet 9 conveyed along the sheet conveyance path 300. The image forming portion 4 includes a photoconductor 41, a charging portion 42, a developing portion 43, a transfer portion 45, a cleaning portion 47, an optical scanning portion 48 and a fixing portion 49. The optical scanning portion 48 is a so-called LSU (Laser Scanning Unit).

Among conveyance rollers 31 located on the upstream side of the transfer portion 45 in the sheet conveyance direction in the sheet conveyance path 300, a conveyance roller 31 closest to the transfer portion 45 is a registration roller 31a. In addition, a sheet detection sensor 4s is disposed on the upstream side of the registration roller 31a in the sheet conveyance direction.

The sheet 9 reaches the registration roller 31a after an ellapse of a predetermined time period since it is detected by the sheet detection sensor 4s. The registration roller 31a adjusts the timing of feeding the sheet 9 to the transfer portion 45 by temporarily stopping the rotation thereof at a timing when the sheet 9 reaches the registration roller 31a and then starting to rotate.

The act of the registration roller 31a is used to adjust an image formation position on the sheet 9 in the sheet conveyance direction.

In the image forming portion 4, the drum-like photoconductor 41 rotates, and the charging portion 42 uniformly charges the surface of the photoconductor 41. The optical scanning portion 48 writes an electrostatic latent image on the surface of the photoconductor 41 by scanning a light beam BO on the surface of the photoconductor along the main direction D0. That is, the main direction D0 is a so-called main scanning direction.

The developing portion 43 develops the electrostatic latent image on the surface of the photoconductor 41 into a toner image by supplying toner to the photoconductor 41. The transfer portion 45 transfers the toner image from the surface of the photoconductor 41 to the sheet 9 conveyed along the sheet conveyance path 300.

It is noted that in a tandem-type color image forming apparatus, the image forming portion 4 includes a primary transfer portion, an intermediate transfer belt that is an endless belt, and a secondary transfer portion.

The primary transfer portion transfers the toner image from the surface of the photoconductor 41 to the intermediate transfer belt that is being rotating. The secondary transfer portion transfers the toner image from the intermediate transfer belt to the sheet 9 conveyed along the sheet conveyance path 300. In this case, the primary transfer portion, the intermediate transfer belt, and the secondary transfer portion are an example of the transfer portion configured to transfer the toner image from the surface of the photoconductor 41 to the sheet 9.

The cleaning portion 47 removes toner that has remained on the surface of the photoconductor 41. The fixing portion 49 fixes the toner image to the sheet 9 by heating the toner image on the surface of the sheet 9.

As described above, the sheet 9 fed from the sheet cassette 2 is conveyed along the sheet conveyance path 300 whose width direction matches the attachment direction D1. In this case, if the sheet cassette 2 is positionally deviated with respect to the main body 1 in the attachment direction D1, the image formed on the sheet 9 is deviated in the width direction of the sheet 9.

Meanwhile, in the image forming apparatus 10, it is troublesome to accurately adjust the positions of the sheet cassettes 2 in the attachment direction D1 for each apparatus.

The image forming apparatus 10 has a configuration for preventing a positional deviation of the image formed on the sheet 9, without requiring a work to accurately adjust, for each apparatus, the position of the sheet cassettes 2 with respect to the main body 1 in the attachment direction D1. The configuration is described in the following.

[Position Detecting Portion 6]

The image forming apparatus 10 includes a position detecting portion 6 that detects the position of the first movable sheet guide 23a in the main direction D0 on the basis of the main body 1. It is noted that the first movable sheet guide 23a is an example of the detection-target portion that is a part of the sheet cassette 2.

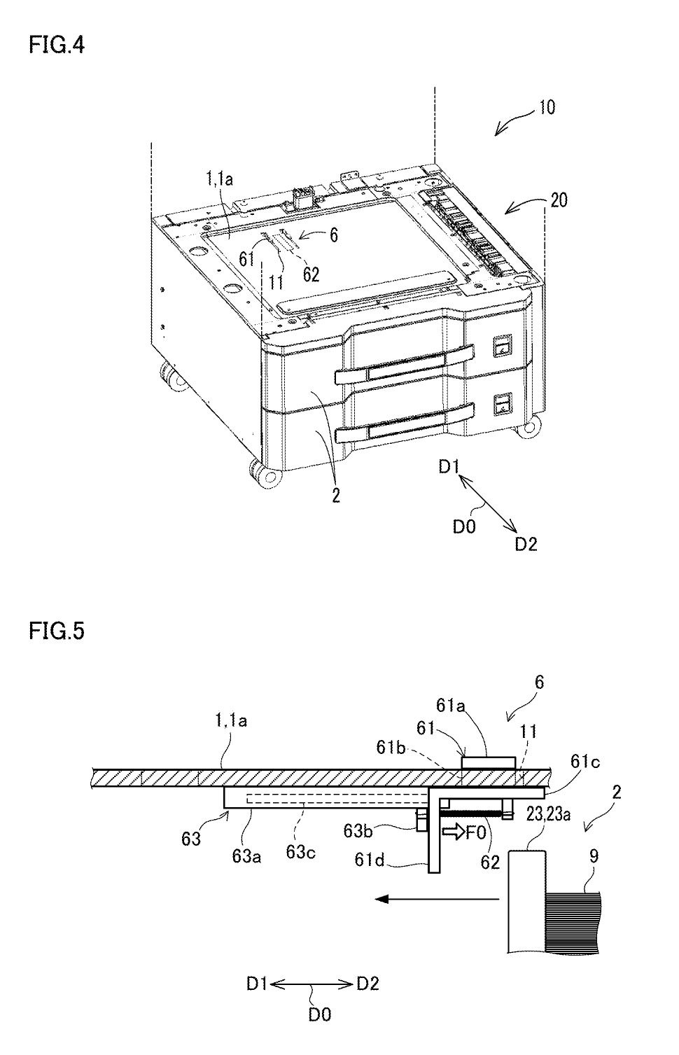

As shown in FIG. 4, the position detecting portion 6 is attached to a top plate portion 1a that covers the upper side of the sheet cassette 2 attached to the main body 1. The top plate portion 1a is a part of the main body 1.

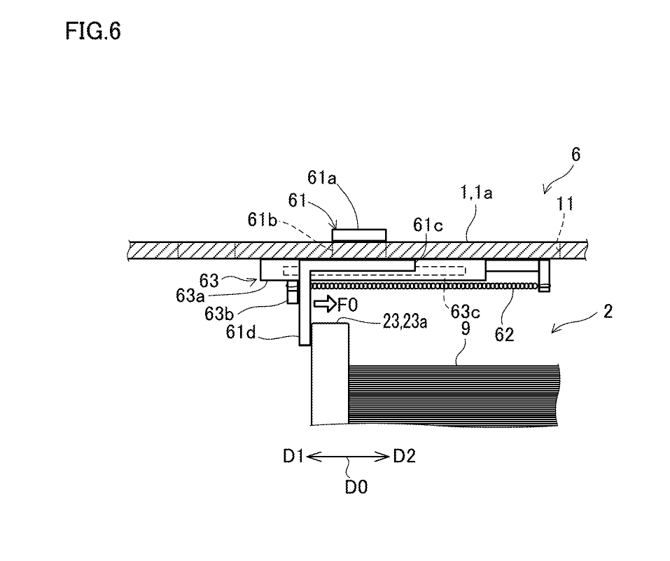

As shown in FIG. 5 and FIG. 6, the position detecting portion 6 includes a displaceable portion 61, a spring 62, and a displacement sensor 63.

The displaceable portion 61 is supported by the top plate portion 1a in such a way as to be displaced along the main direction D0. As shown in FIG. 4 and FIG. 5, the top plate portion 1a has an elongated hole 11 that extends along the main direction D0, and the displaceable portion 61 is attached to a rim portion of the elongated hole 11 of the top plate portion 1a so as to be slidable along the main direction D0.

As shown in FIG. 5 and FIG. 6, the displaceable portion 61 includes an upper flange portion 61a, a through portion 61b, a lower flange portion 61c, and a downward protruding portion 61d. The upper flange portion 61a is configured to contact a rim portion of the elongated hole 11 on the upper surface of the top plate portion 1a. The through portion 61b is a portion penetrating through the elongated hole 11. The lower flange portion 61c is configured to contact a rim portion of the elongated hole 11 on the lower surface of the top plate portion 1a. The downward protruding portion 61d protrudes from the lower flange portion 61c downward.

The upper flange portion 61a, the through portion 61b, and the lower flange portion 61c are supported by the top plate portion 1a so as to be displaceable along the main direction D0. When the sheet cassette 2 is attached to the main body 1, the downward protruding portion 61d contacts the first movable sheet guide 23a of the sheet cassette 2 from the downstream side in the attachment direction D1.

As shown in FIG. 2 and FIG. 3, among the four partition wall portions 22 of the sheet cassette 2, a partition wall portion 22a that is located on the downstream side in the attachment direction D1, has a cut portion 220. The cut portion 220 is formed in the partition wall portion 22a at a portion facing the first movable sheet guide 23a.

The cut portion 220 becomes a passage of the downward protruding portion 61d when the sheet cassette 2 is attached to the main body 1. This allows the downward protruding portion 61d to contact the first movable sheet guide 23a from the downstream side in the attachment direction D1 without colliding with the partition wall portion 22a.

The spring 62 is an elastic member that applies an elastic force F0 that is directed to the upstream side in the attachment direction D1, to the displaceable portion 61. In the example shown in FIG. 5 and FIG. 6, the spring 62 is a tension spring. It is noted that a compression spring or a helical spring may be adopted as the spring 62.

The displacement sensor 63 is fixed to the top plate portion 1a. The displacement sensor 63 detects a position of the displaceable portion 61 in the main direction D0 on the basis of the top plate portion 1a. In the example shown in FIG. 5 and FIG. 6, the displacement sensor 63 is a variable-resistor-type displacement meter configured to detect a displacement amount in a straight line direction. The variable-resistor-type displacement meter is low in cost.

The displacement sensor 63 includes a sensor main body portion 63a and a slide portion 63b, wherein the sensor main body portion 63a incorporates a variable resistor 63c, and the slide portion 63b can slide with respect to the sensor main body portion 63a along the main direction D0. Electrical resistance of the variable resistor 63c in the sensor main body portion 63a changes in response to a position of the slide portion 63b along the main direction D0.

In the present embodiment, an end of the spring 62 is coupled with the top plate portion 1a, and the other end of the spring 62 is coupled with the slide portion 63b of the displacement sensor 63. The spring 62 applies the elastic force F0 to the displaceable portion 61 via the slide portion 63b.

It is noted that the displaceable portion 61 may be coupled with the slide portion 63b, and the spring 62 may apply the elastic force F0 directly to the displaceable portion 61.

As shown in FIG. 5, in a state where the sheet cassette 2 is not attached to the main body 1, due to the elastic force F0 applied by the spring 62, the displaceable portion 61 and the slide portion 63b are held at a position on the most upstream side in the attachment direction D1 within a movable range in the main direction D0.

As shown in FIG. 6, when the sheet cassette 2 is attached to the main body 1, the downward protruding portion 61d of the displaceable portion 61 contacts the first movable sheet guide 23a from the downstream side in the attachment direction D1. Then upon receiving the force in the attachment direction D1 from the first movable sheet guide 23a, the displaceable portion 61 and the slide portion 63b are displaced toward the downstream side in the attachment direction D1 against the elastic force F0 from the spring 62.

In addition, the elastic force F0 of the spring 62 maintains the state where the downward protruding portion 61d contacts the first movable sheet guide 23a. Accordingly, the position detected by the displacement sensor 63 in the state where the sheet cassette 2 is attached to the main body 1 represents the position of the first movable sheet guide 23a in the main direction D0 on the basis of the main body 1.

In addition, the position of the first movable sheet guide 23a in the main direction D0 on the basis of the main body 1 represents the position of the sheets 9 in the main direction D0 on the basis of the main body 1. That is, the position detected by the position detecting portion 6 represents the position of the sheets 9 in the main direction D0 on the basis of the main body 1.

In general, the size of the sheets 9 in each sheet cassette 2 would be any of a plurality of regular sheet sizes such as a letter size, A4 size, and B5 size. In this case, in the state where the sheet cassette 2 is attached to the main body 1, it is possible to determine, from the position of the first movable sheet guide 23a, which of the plurality of regular sheet sizes the size of the sheets 9 in the main direction D0 is.

The control portion 8 includes a sheet size determining portion 81 that determines, from the position detected by the position detecting portion 6, the size of the sheets 9 in the sheet cassette 2 (see FIG. 1).

The sheet size determining portion 81 compares the position detected by the position detecting portion 6 with a predetermined plurality of candidate positions that correspond the plurality of regular sheet sizes. Subsequently, the sheet size determining portion 81 determines, as the size of the sheets 9 in the sheet cassette 2, a regular sheet size that corresponds to, among the plurality of candidate positions, a candidate position that is closest to the position detected by the position detecting portion 6.

It is noted that in a conventional apparatus, a sheet size sensor for detecting the size of the sheets 9 may be attached to the sheet cassette 2. In the present embodiment, the sheet size sensor attached to the sheet cassette 2 in the conventional apparatus is not required.

Here, a standard timing when the optical scanning portion 48 starts to write the electrostatic latent image for each line in the main scanning direction, is referred to as a standard timing. In addition, when the writing of the electrostatic latent image is performed at the standard timing, a position of the sheets 9 in the main direction D0 for an image to be formed at an original position in the width direction of the sheets 9, is referred to as a standard sheet position.

The control portion 8 stores, in advance, a standard detection position for each size of the sheets 9 in the main direction D0, wherein the standard detection position is a detection position of the position detecting portion 6 corresponding to the standard sheet position.

The control portion 8 includes an image position correcting portion 82 that corrects an image formation position in the main direction D0 at which the image is formed by the image forming portion 4, based on the position detected by position detecting portion 6 (see FIG. 1).

In the present embodiment, the image position correcting portion 82 corrects the timing when the optical scanning portion 48 starts to write the electrostatic latent image, based on the position detected by the position detecting portion 6. Specifically, the image position correcting portion 82 calculates a correction time which is proportional to a difference between the detected position and the standard detection position corresponding to the size of the sheets 9 in the main direction D0.

Subsequently, the image position correcting portion 82 corrects the timing when the optical scanning portion 48 starts to write the electrostatic latent image for each line in the main scanning direction, to a timing obtained by shifting the standard timing by the correction time.

In the present embodiment, the sheet size determining portion 81 automatically determines the size of the sheets 9 in the main direction D0. It is noted that the size of the sheets 9 may be set via an operation portion (not shown) included in the image forming apparatus 10.

With the adoption of the image forming apparatus 10, even if the position of the sheet 9 in the main direction D0 is deviated from the standard sheet position due to a variation in attachment state of the sheet cassette 2 with respect to the main body 1, the image is formed at the original position in the width direction of the sheet 9. That is, it is possible to prevent the image formed on the sheet 9 from being positionally deviated in the width direction.

In addition, with the adoption of the image forming apparatus 10, it is possible to omit the work of accurately adjusting, for each apparatus, the position of the sheet cassettes 2 in the main direction D0 with respect to the main body 1.

The displaceable portion 61 and the displacement sensor 63 are relatively small parts and have high dimensional accuracy. In addition, the sensor main body portion 63a of the displacement sensor 63 is fixed to the top plate portion 1a at a predetermined position. In this case, there is a very small variation among apparatuses in the movable range of the slide portion 63b in the main direction D0.

Accordingly, the control portion 8 may include a standard detection position setting portion 83 that sets the standard detection position for each size of the sheets 9 in the main direction D0, based on the maximum value and the minimum value among values detected by the displacement sensor 63. The standard detection position setting portion 83 sets the standard detection position for each size of the sheets 9 in the main direction D0, and stores the set values in a nonvolatile storage portion.

More specifically, the standard detection position setting portion 83 obtains the maximum value and the minimum value among values detected by the displacement sensor 63 that are obtained in cases where the slide portion 63b is located at opposite ends of the movable range in the main direction D0.

Furthermore, the standard detection position setting portion 83 calculates, by linear interpolation, an interpolation value for each size of the sheets 9, from the maximum value and the minimum value among values detected by the displacement sensor 63, by using an interpolation coefficient that is set in advance for each size of the sheets 9 in the main direction D0. The standard detection position setting portion 83 then stores, in the storage portion, the interpolation values for the sizes of the sheets 9 as data of the standard detection position for each size of the sheets 9.

### Application Examples

In the position detecting portion 6 of the image forming apparatus 10 described above, a so-called potentiometer may be adopted as the displacement sensor 63. The potentiometer is a rotation type variable resistor. In this case, a rotation shaft of the potentiometer may be coupled with the displaceable portion 61 by the rack and pinion mechanism. In this case, the pinion is connected to the rotation shaft of the potentiometer, and the rack is integral with the displaceable portion 61.

In addition, the position detecting portion 6 may include a link mechanism. The link mechanism includes a secondary displaceable portion that is interlocked with the displaceable portion 61, and is displaced in the main direction D0 within a smaller range than the displaceable portion 61. The secondary displaceable portion is displaced by a displacement amount that is proportional to a displacement amount of the displaceable portion 61 that is a primary displaceable portion.

The displacement sensor 63 may detect the position of the secondary displaceable portion. This makes it possible to adopt a small displacement sensor 63 that can detect a small amount of displacement. In addition, the displacement sensor 63 may be a contactless sensor.

In addition, the position detecting portion 6 may detect a position of a portion other than the first movable sheet guide 23a of the sheet cassette 2. For example, the position detecting portion 6 may detect a position of the partition wall portion 22a of the sheet cassette 2 in the main direction D0. In this case, a sensor for detecting the size of the sheets 9 in the sheet cassette 2 may be provided in the sheet cassette 2.

In addition, the position detecting portion 6 may detect a position of a portion that is interlocked with the first movable sheet guide 23a. For example, the position detecting portion 6 may detect a position of one of the pair of racks 25 that are interlocked with the first movable sheet guide 23a.

In a situation where the size of the sheets 9 in the sheet cassette 2 has already been known, it is possible to detect the position of the sheets 9 on the basis of the main body 1 when the position of the partition wall portion 22a in the main direction D0 is detected on the basis of the main body 1.

In addition, the position detecting portion 6 may be applied to an image forming apparatus that implements a method other than the electrophotography, such as an ink jet printer. An image forming portion of the ink jet printer includes an ink jet head that moves along the main direction D0. In this case, the image position correcting portion 82 corrects, in correspondence with the position detected by the position detecting portion 6, corrects the timing when the ink jet head starts to eject the ink. In this way, it is possible to correct an image formation position in the main direction D0 of the image formation by the ink jet head.

It is noted that the image forming apparatus of the present disclosure may be configured by freely combining, within the scope of claims, the above-described embodiments and application examples, or by modifying the embodiments and application examples or omitting a part thereof.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a sheet cassette configured to store sheets and be attached to and drawn out from an apparatus main body along a main direction;
a sheet conveying portion configured to convey a sheet from the sheet cassette attached to the apparatus main body, along a sheet conveyance path whose width direction matches the main direction;
an image forming portion configured to form an image on the sheet conveyed along the sheet conveyance path;
a position detecting portion configured to detect a position of a detection-target portion that is a part of the sheet cassette, in the main direction on a basis of the apparatus main body; and
an image position correcting portion configured to correct an image formation position in the main direction at which the image is formed by the image forming portion, based on the position detected by the position detecting portion.

2. The image forming apparatus according to claim 1, wherein
the sheet cassette includes:
a movable sheet guide provided in such a way as to be displaced along the main direction in the sheet cassette, and is positioned to extend along an end of the sheets in the main direction, and
the detection-target portion is the movable sheet guide or a portion interlocked with the movable sheet guide.

3. The image forming apparatus according to claim 2, further comprising:
a sheet size determining portion configured to compare the position detected by the position detecting portion with a predetermined plurality of candidate positions that correspond to a plurality of sheet sizes, and determine, as a size of the sheets in the sheet cassette, a sheet size that corresponds to, among the plurality of candidate positions, a candidate position that is closest to the position detected by the position detecting portion.

4. The image forming apparatus according to claim 1, wherein
the position detecting portion includes:
a displaceable portion supported by the apparatus main body in such a way as to be displaced along the main direction;
an elastic member configured to apply, to the displaceable portion, an elastic force that is directed to an upstream side in the attachment direction of the sheet cassette; and
a displacement sensor configured to detect a position of the displaceable portion in the main direction based on the apparatus main body, and
when the sheet cassette is attached to the apparatus main body, the displaceable portion contacts the detection-target portion from a downstream side in the attachment direction, and is displaced toward the downstream side in the attachment direction against the elastic force from the elastic member.

5. The image forming apparatus according to claim 4, wherein
the displacement sensor is a variable-resistor-type displacement meter.

6. The image forming apparatus according to claim 1, wherein
the image forming portion includes:
an optical scanning portion configured to write an electrostatic latent image on a surface of a photoconductor by scanning a light beam on the surface of the photoconductor along the main direction;
a developing portion configured to develop the electrostatic latent image on the surface of the photoconductor into a toner image; and
a transfer portion configured to transfer the toner image from the surface of the photoconductor to the sheet conveyed along the sheet conveyance path, and
the image position correcting portion corrects a timing when the optical scanning portion starts to write the electrostatic latent image, based on the position detected by the position detecting portion.
